(19) United States
(12) Patent Application Publication
(10) Pub. No.: US 2023/0123380 A1
(43) Pub. Date: Apr. 20, 2023

(54) METHOD FOR FORMING A BAKED GOOD

(71) Applicant: Parlor Doughnuts Franchising, LLC, Evansville, IN (US)

(72) Inventor: Darrick R. Hayden, Evansville, IN (US)

(21) Appl. No.: 17/970,045

(22) Filed: Oct. 20, 2022

Related U.S. Application Data
(60) Provisional application No. 63/257,932, filed on Oct. 20, 2021.

(51) Int. Cl. A21C 11/00; A21D 13/60

(52) U.S. Cl. CPC A21C 11/002; A21D 13/60

(57) ABSTRACT

A method for forming a donut by manipulating dough. This method includes forming a first tip located on a first side of the dough and forming a second tip located on a second side of the dough, manipulating the dough into a partially arc shaped configuration wherein the first and second tips are held pointing outwardly, placing an object within the arc, wrapping the second tip of the dough around the object, crossing the second tip over the first side of the dough forming a hole in the dough where the object is located, removing the object from within the arc, and wrapping the tips around the side of the dough and through the hole and rubbing the dough to smooth hanging tips. The dough is completed to be formed in a one-piece round shape resembling a circle.

### CROSS-REFERENCE TO RELATED DISCLOSURES

The present disclosure claims the benefit of U.S. Provisional Application No. 63/257,932 filed on Oct. 20, 2021 and titled “METHOD FOR FORMING A BAKED GOOD”, the contents of which are incorporated herein in entirety.

### FIELD OF THE DISCLOSURE

The present disclosure relates to a method for forming a baked good, and more particularly to a method for both forming and baking the baked good.

### BACKGROUND

Baked goods, such as donuts, are typically appealing to consumers for their taste, shape, texture, and consistency among other things. A typical donut is formed from an injection device that forces the dough around a centralized nozzle before cutting the dough into a circular shape. Accordingly, the typical round donut can only be flavored via the dough forced through the nozzle and a surface coating. The present disclosure provides a unique forming process that allows for a circular donut to have a unique shape and taste over the conventional donut for at least the reasons explained herein.

### SUMMARY

One embodiment is a method for manipulating dough. The method includes placing a frozen layered dough on a fry screen, thawing the dough in air without allowing the dough to proof, manipulating the dough, placing the dough in a proofer to rise, frying the dough, rolling the dough in a sugar bath mixture, and one or more of filling and glazing the dough.

In one example of this embodiment, the dough used is private label dough. In another example, the dough is retarded to prevent the dough from proofing during the air thawing process. In yet another example, the dough is manipulated by forming a left tip located on a left side and by forming a right tip located on a right side, the dough is manipulated into an at least partially arc shape wherein the left and right tips are held pointing outwardly and an object is placed within the arc, the right tip of the dough is at least partially wrapped around the object and the right tip is crossed over the left side of the dough forming a hole in the dough where the object is located, the object is removed from within the arc and the tips are wrapped around the side of the dough and through the hole, and the dough is rubbed to be smooth to eliminate hanging tips to ensure the dough is formed in a one-piece round shape resembling a circle, and to eliminate a center hole.

In yet another example of this embodiment, the dough is retarded before frying. In yet another example, the dough is fried in an oil bath. In another example, the dough comprises enriched flour. In one aspect of this example, the dough comprises wheat flour, niacin, iron, thiamine, riboflavin, and folic acid. In another aspect of this example, the dough comprises water, palm oil, butter, yeast, sugar, canola oil. In yet another aspect of this example, the dough comprises less than 2% of annatto, ascorbic acid, citric acid, egg whites, enzymes, monoglycerides, natural flavor salt, soy lecithin, and whey.

Another embodiment of this disclosure is a method for forming a donut by manipulating dough. This method includes forming a first tip located on a first side of the dough and forming a second tip located on a second side of the dough, manipulating the dough into a partially arc shaped configuration wherein the first and second tips are held pointing outwardly, placing an object within the arc, wrapping the second tip of the dough around the object, crossing the second tip over the first side of the dough forming a hole in the dough where the object is located, removing the object from within the arc, and wrapping the tips around the side of the dough and through the hole and rubbing the dough to smooth hanging tips. The dough is completed to be formed in a one-piece round shape resembling a circle.

Another embodiment is a method of forming dough into a shape. The method includes providing a dough formed in a tapered crescent shape, the dough having a first tapered end and a second tapered end, positioning the first tapered end over the second tapered end, wrapping the first tapered end around the second tapered end, pulling the first tapered end through a hole defined in the dough, pressing an overlap section of the first tapered end into the second tapered end, and forming the dough into a circular shape.

One example of this method includes positioning an obstruction along a center section of the dough formed in the tapered crescent shape before positioning the first tapered end over the second tapered end. In part of this example, the obstruction remains along the center section until the first tapered end is pulled through the hole defined in the dough.

In one example of this embodiment, the dough formed in the tapered crescent shape is formed by rolling a sheet of dough. In part of this example, the dough is formed in the tapered crescent shape by creating a rectangular sheet of dough and rolling the sheet of dough from a first corner to a second corner. Another part of this example includes adding a surface coating to the sheet of dough before it is formed in the tapered crescent shape.

Yet another example of this embodiment includes placing the dough formed in the circular shape in a proofer to rise. Part of this example includes frying the dough after it was placed in the proofer to rise. Another part of this example includes rolling the dough in a sugar bath mixture. Yet another part of this example includes at least one of filling, finishing, or glazing the dough.

Another embodiment of this disclosure is a substantially circular shaped food item. The food item has a dough body formed of a rolled sheet of dough, a center section of the dough body having a thickness that is greater than a first tapered end and a second tapered end of the dough body, and an overlap section of the dough body formed by the first tapered end. The overlap section at least partially overlaps the second tapered end to form the dough body into a substantially annular food item.

In one example of this embodiment the center section and the overlap section are aligned with a longitudinal axis. In part of this example, the center section has a first edge and a second edge each equidistantly spaced from opposing sides of the longitudinal axis. In another part of this example, the overlap section has a first edge and a second edge each equidistantly spaced from opposing sides of the longitudinal axis. In yet another part of this example, the dough body defines a first intermediate edge and a second intermediate edge each equidistantly spaced from opposing sides of the longitudinal axis.

In yet another example of this embodiment, a cross-section of the center section of the dough body has a helical pattern of the rolled sheet of dough.

Yet another embodiment of this disclosure is a method for manipulating dough. The method includes forming a first tapered end and a second tapered end in the dough, manipulating the dough into a tapered crescent shape wherein the first and second tapered ends are positioned around an obstruction that is placed within the tapered crescent shape, wrapping the first tapered end of the dough around the obstruction and crossing the first tapered end over the second tapered end of the dough to form a hole in the dough where the obstruction is located, and wrapping the first tapered end around the second tapered end and pulling the first tapered end through the hole to form a circular shape.

One example of this embodiment includes rubbing the dough to eliminate hanging tips. Another example includes pressing the dough radially inward to ensure the dough is formed in the circular shape and to eliminate the hole. Yet another example includes placing the dough in a proofer to rise, frying the dough, rolling the dough in a sugar bath mixture, and one or more of filling and glazing the dough.

### DRAWINGS

The above-mentioned aspects of the present disclosure and the manner of obtaining them will become more apparent and the disclosure itself will be better understood by reference to the following drawings:

FIG. 1 is an exemplary flowchart of one embodiment of this disclosure; and

FIG. 2a is an schematic view of a sheet of dough;

FIG. 2b is a dough body in a tapered crescent shape;

FIG. 2c is the dough body of FIG. 2b in a partially overlapped state;

FIG. 2d is the dough body of FIG. 2b in a partially underlapped state;

FIG. 2e is the dough body of FIG. 2b with a first tapered end positioned through a hole of the dough body;

FIG. 2f is the dough body of FIG. 2b with the first tapered end stretched from the hole;

FIG. 2g is the dough body of FIG. 2b in a substantially circular form;

FIG. 2h is a cross section view of a center section of the dough body of FIG. 2b; and

FIG. 2i is a cross section view of a tapered end of the dough body of FIG. 2b

Corresponding reference numerals indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

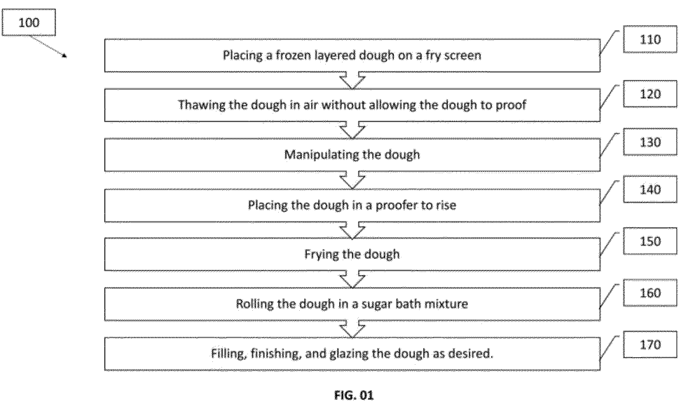

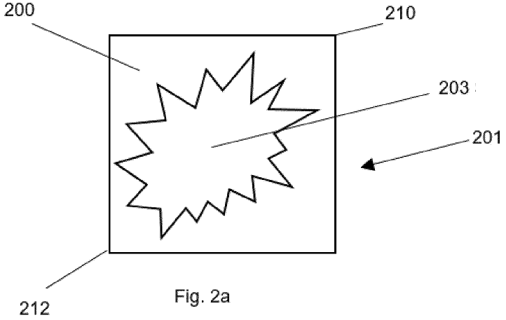

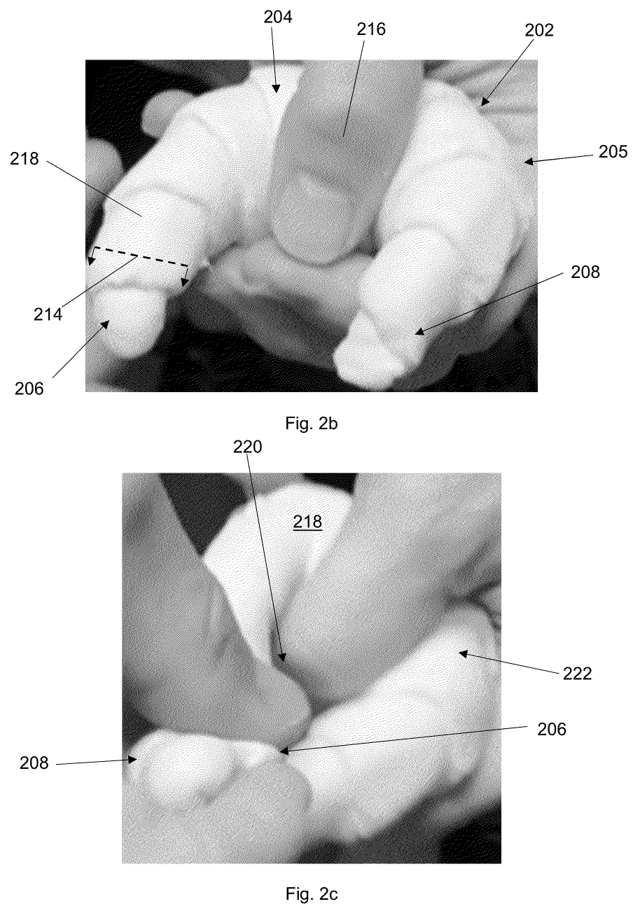

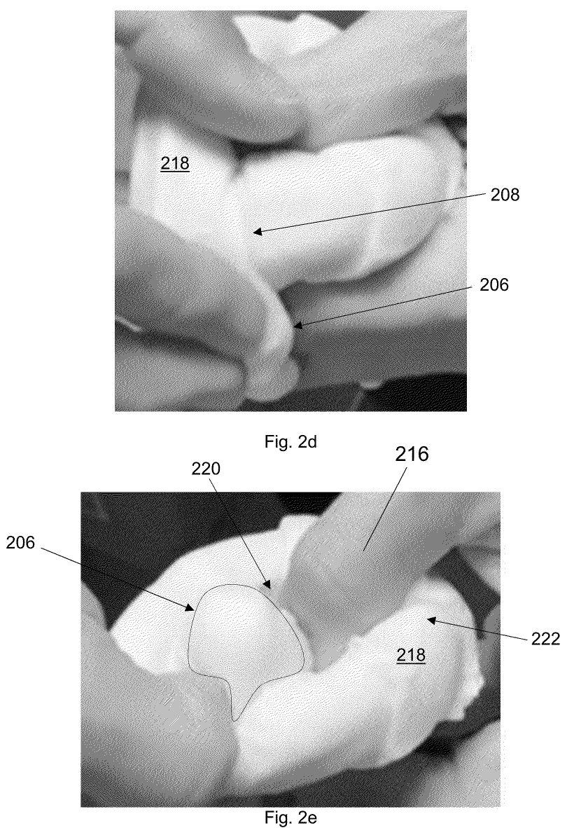

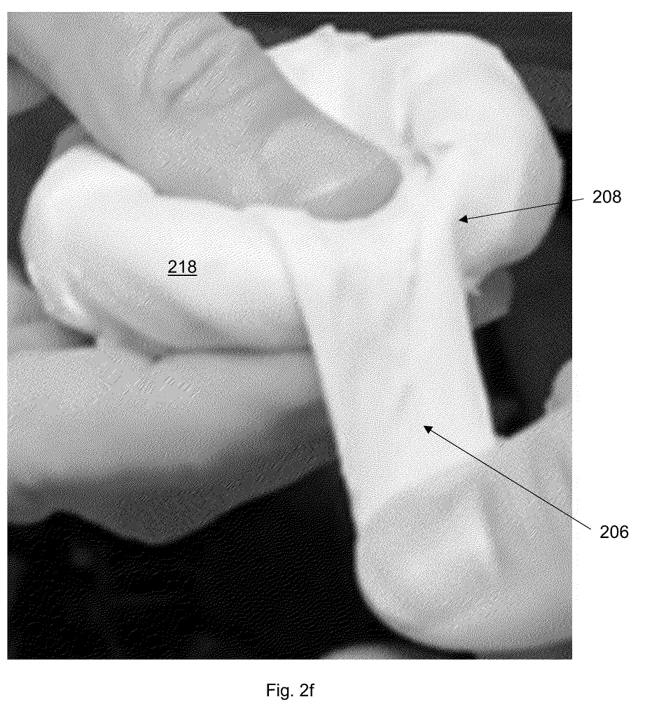

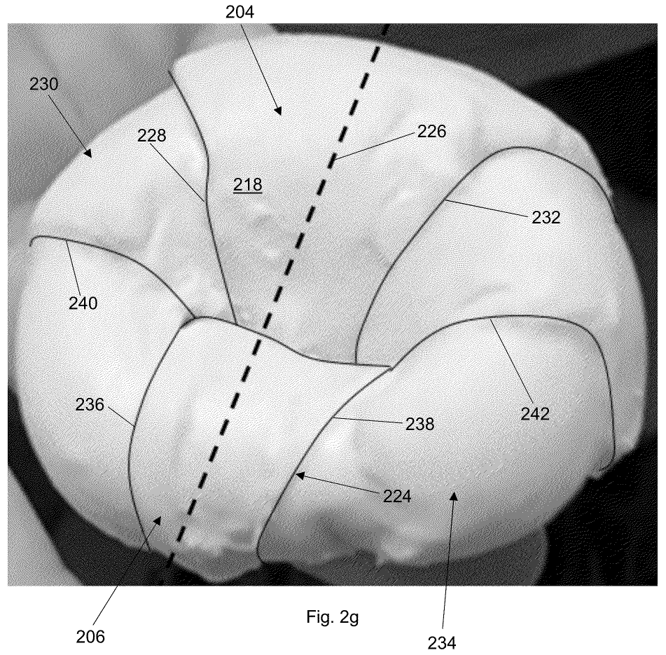

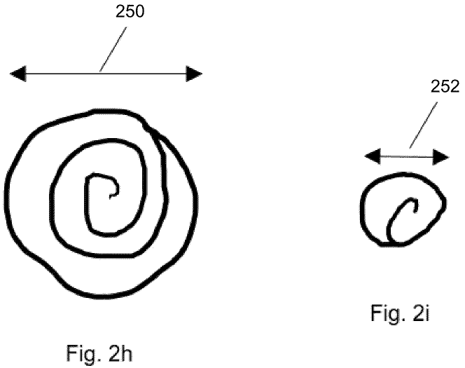

In one non-exclusive embodiment, a baked good, such as a donut, may be formed as outlined in the flowchart 100 of FIG. 1. More specifically, dough may be formed and frozen. Initially, a frozen layer of dough may be placed on a fry screen in box 110. The dough may be thawed in box 120 via air without allowing the dough to proof. In box 130, the dough may be manipulated to a desired form. In box 130, the dough may be formed into a substantially flat square and then rolled from one corner to the adj acent corner to create a tapered cross section. The surface of the dough may be flavored prior to rolling the dough to provide flavored layers throughout the tapered cross-section. After creating the tapered cross section, the dough may be further manipulated as outlined herein with reference to FIGS. 2a-2f. In box 140, the dough is placed in a proofer and allowed to rise. The user may retard the dough if necessary before frying in box 140. In one non-exclusive example, the dough may be placed in a refrigerated environment to retard the dough. Regardless, once the user determines the dough is ready, in box 150 the dough may be fried. In box 160, the dough may be rolled in a sugar bath mixture or any other type of mixture. For example, the sugar bath mixture may be a liquid containing sugar. Further still, the sugar bath mixture could also include other flavoring ingredients. In box 170, the dough may be filled, finished, and/or glazed as desired.

Referring now to FIGS. 2a-2i, one method for the manipulating the dough step of box 130 is illustrated. More specifically, the dough may be rolled to create a dough body 205 having a tapered crescent shape 202 as illustrated in FIG. 2b. The tapered crescent shape 202 may be formed by pressing a sheet of dough 200 into a rectangular shape 201. In one example, the sheet of dough 200 is in a square shape prior to being rolled into the tapered crescent shape 202. In one embodiment, a surface coating 203 may be applied to the sheet of dough 200 while in the rectangular shape 201 such that the surface coating 203 is positioned between adjacent layers of the dough when formed into the tapered crescent shape 202. The surface coating 203 contemplated herein could be one or more of butter, flower, sugar, cinnamon sugar, cinnamon, or any other known coating used in baked goods. Whether a surface coating is applied to the sheet of dough in the rectangular shape, the sheet of dough 200 may be rolled starting with a first corner 210 and rolling the sheet of dough 200 diagonally towards an opposite second corner 212 to form the dough body 205 having the tapered crescent shape 202 illustrated in FIG. 2b.

The tapered crescent shape 202 may have a center section 204 that is thicker than a first tapered end 206 and a second tapered end 208. As discussed herein, the diagonal rolling of the rectangular sheet of dough 200 creates the center section 204 having a thicker cross-section and more layers of dough than the first and second tapered ends 206, 208. For example, FIG. 2h illustrates a cross-section view of the tapered crescent shape 202 through the center section 204 while FIG. 2i illustrates a cross-section view of the tapered crescent shape 202 through a section 214 of the first tapered end 206. As illustrated in FIGS. 2h and 2i, the cross section of the center section 204 has a greater width 250 and more layers than the tapered cross section 214, which has a width 252 that is less than the width 250.

In FIGS. 2b-2g illustrate one method of tying dough 218 formed in the tapered crescent shape 202. In FIG. 2b, a user or machine may hold the dough 218 with an obstruction 216 next to the center section 204 through the middle of the tapered crescent shape 202. If a human user is tying the dough 218, the obstruction 216 may be a user’s finger or thumb. However, if a machine is tying the dough 218, the obstruction may be a cylindrical component. Regardless, in FIG. 2c the first tapered end 206 of the dough 218 is crossed over the second tapered end 208 of the dough 218 while the obstruction 216 remains in the middle section of the tapered crescent shape 202. The first and second tapered ends 206, 208 may be crossed by a user with an opposing hand or by a third party. Alternatively, a machine may have an automated process wherein both of the first and second tapered ends 206, 208 are grabbed by separate pinching mechanisms and moved to the crossed position illustrated in FIG. 2c.

In FIG. 2d, the first tapered end 206 is passed underneath and around the second tapered end 208. The dough 218 of the first tapered end 206 may be stretched or otherwise manipulated by the user or machine to pass entirely underneath the second tapered end 208 and be positioned on a bottom side of the dough 218 relative to the perspective illustrated in FIG. 2d. The first tapered end 206 may be positioned as illustrated in FIG. 2d by a user, by an assistant of the user, or by a machine.

In FIG. 2e, the first tapered end 206 is passed up through a hole 220 next to the obstruction 216 in the middles section of the dough 218. The first tapered end 206 is stretched or otherwise positioned through the hole 220 to at least partially extend out a top side 222 of the dough 218. This step may be performed by a user or machine slightly stretching the dough 218 from the obstruction 216 by slightly pulling the first and second tapered end 206, 208 away from the obstruction 216 to enlarge the hole 220 as the first tapered end 206 is transitioned there through. The first tapered end 206 may be transitioned through the hole 220 either with a user or assistants finger or thumb or via a pushing element of a machine.

In FIG. 2f, the first tapered end 206 is stretched downward around the second tapered end 208. The second tapered end 208 of the dough 218 may be stretched by the user or machine sufficiently far to allow the first tapered end 206 to be positioned at least partially on the bottom side of the dough 218 from the perspective of FIG. 2f. More specifically, the first tapered end 206 may ultimately be positioned along, and coupled to, the second tapered end 208 as illustrated in FIG. 2f. In FIG. 2f, the first tapered end 206 is pressed against the underside of the second tapered end 206 and the obstruction 216 is removed from the hole 220. The exterior of the dough 218 may then be further manipulated to smooth any sharp edges. Further, the user or machine may manipulate the substantially circular dough 218 to be formed to create a substantially circular shape as illustrated. Once the dough 218 is formed as illustrated in FIG. 2g, boxes 140-170 may be implemented on the formed dough 218.

In one aspect of this disclosure, the first tapered end 206 may form an overlap section 224 over the second tapered end 208. In this configuration, the reduced widths of the first and second tapered ends 206, 208 may be increased by the added overlap section 224. Further, the overlap section 224 may be substantially aligned with the center section 204 along a longitudinal axis 226 through the center section 204 and the overlap section 224.

The center section 204 may have a first edge 228 on a first side 230 of the longitudinal axis 226 and a second edge 232 on a second side 234 of the longitudinal axis 226. The first and second side 230, 232 of the center section 204 may be about equidistantly spaced from the longitudinal axis 226 along corresponding points. Similarly, the overlap section 224 may define a first edge 236 on the first side 230 and a second edge 238 on the second side 234. The first and second edge 236, 238 of the overlap section 224 may be about equidistantly spaced from the longitudinal axis 226 along corresponding points. Further still, a first intermediate edge 240 may defined in the dough 218 on the first side 230 and a second intermediate edge 242 may be formed in the dough 218 on the second side 234. The first and second intermediate edge 240, 242 of the dough 218 may be about equidistantly spaced from the longitudinal axis 226 along corresponding points. In one aspect of this disclosure, both the center section 204 and the overlap section 224 have a tapered geometry from the perspective of FIG. 2g such that the upper portion of the center section 204 and overlap section 224 is wider than the lower portion of the respective center section 204 and overlap section 224.

The method of forming the dough 218 as illustrated in FIG. 2g provides for a substantially mirrored form of the dough 218 along the longitudinal axis 226. This provides an appealing visual balance to the dough 218 in final form. Further, by positioning the overlap section 224 along the tapered ends 206, 208, the thickness of the thinner portions of the dough 218 in the tapered crescent shape 202 is increased so the dough 218 of FIG. 2g ha a more uniform thickness throughout radial cross-section.

This disclosure contemplates implementing the method of forming the dough 218 discussed herein with human user or with a machine. A user may use their fingers or other tools to manipulate the dough as discussed herein. Alternatively, a machine may be designed to manipulated the dough 218 as described herein via a control system that controls actuators, motors, linkages, and the like to manipulate the dough 218.

While embodiments incorporating the principles of the present disclosure have been described hereinabove, the present disclosure is not limited to the described embodiments. Instead, this application is intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method of forming dough into a shape, comprising:
providing a dough formed in a tapered crescent shape, the dough having a first tapered end and a second tapered end;
positioning the first tapered end over the second tapered end;
wrapping the first tapered end around the second tapered end;
pulling the first tapered end through a hole defined in the dough;
pressing an overlap section of the first tapered end into the second tapered end; and
forming the dough into a circular shape.

2. The method of claim 1, further comprising positioning an obstruction along a center section of the dough formed in the tapered crescent shape before positioning the first tapered end over the second tapered end.

3. The method of claim 2, wherein the obstruction remains along the center section until the first tapered end is pulled through the hole defined in the dough.

4. The method of claim 1, wherein the dough formed in the tapered crescent shape is formed by rolling a sheet of dough.

5. The method of claim 4, wherein the dough is formed in the tapered crescent shape by creating a rectangular sheet of dough and rolling the sheet of dough from a first corner to a second corner.

6. The method of claim 5, further comprising adding a surface coating to the sheet of dough before it is formed in the tapered crescent shape.

7. The method of claim 1, further comprising placing the dough formed in the circular shape in a proofer to rise.

8. The method of claim 7, further comprising frying the dough after it was placed in the proofer to rise.

9. The method of claim 8, further comprising rolling the dough in a sugar bath mixture.

10. The method of claim 8, further comprising at least one of filling, finishing, or glazing the dough.

11. A food item, comprising:
a dough body formed of a rolled sheet of dough;
a center section of the dough body having a dough body width that is greater than a width of each of a first tapered end and a second tapered end of the dough body; and
an overlap section of the dough body formed by the first tapered end;
wherein, the overlap section at least partially overlaps the second tapered end to form the dough body into a substantially annular food item.

12. The food item of claim 11, wherein the center section and the overlap section are aligned with a longitudinal axis.

13. The food item of claim 12, wherein the center section has a first edge and a second edge each equidistantly spaced from opposing sides of the longitudinal axis.

14. The food item of claim 13, wherein the overlap section has a first edge and a second edge each equidistantly spaced from opposing sides of the longitudinal axis.

15. The food item of claim 14, wherein the dough body defines a first intermediate edge and a second intermediate edge each equidistantly spaced from opposing sides of the longitudinal axis.

16. The food item of claim 11, wherein a cross-section of the center section of the dough body has a helical pattern of the rolled sheet of dough.

17. A method for manipulating dough, the method comprising:
forming a first tapered end and a second tapered end in the dough;
manipulating the dough into a tapered crescent shape wherein the first and second tapered ends are positioned around an obstruction that is placed within the tapered crescent shape;
partially wrapping the first tapered end of the dough around the obstruction and crossing the first tapered end over the second tapered end of the dough to form a hole in the dough where the obstruction is located; and
wrapping the first tapered end around the second tapered end and pulling the first tapered end through the hole to form a circular shape.

18. The method of claim 17, further comprising rubbing the dough to eliminate hanging tips.

19. The method of claim 17, further comprising pressing the dough radially inward to ensure the dough is formed in the circular shape and to eliminate the hole.

20. The method of claim 17, further comprising:
placing the dough in a proofer to rise;
frying the dough;
rolling the dough in a sugar bath mixture; and
one or more of filling and glazing the dough.
